(19) United States
(12) Patent Application Publication
(10) Pub. No.: US 2023/0393827 A1
(43) Pub. Date: Dec. 7, 2023

(54) APPLICATION MANAGEMENT METHOD AND SYSTEM FOR TERMINAL

(71) Applicants: K-TRONICS (SUZHOU) TECHNOLOGY CO., LTD., Suzhou, Jiangsu (CN); BOE Technology Group Co., Ltd., Beijing (CN)

(72) Inventors: Tengteng LI, Beijing (CN); Lixia LU, Beijing (CN); Yutao YAN, Beijing (CN); Min CHEN, Beijing (CN); Renfeng DUAN, Beijing (CN)

(21) Appl. No.: 18/034,208

(22) PCT Filed: Oct. 30, 2020
(86) PCT No.: PCT/CN2020/125462

§ 371 Date: Apr. 27, 2023

(51) Int. Cl. G06F 8/61; G06F 9/451

(52) U.S. Cl. CPC G06F 8/61; G06F 9/451

(57) ABSTRACT

Provided are an application management method and system for a terminal. The application management method is applied to a management end, the terminal being composed of at least one smart interaction tablet. The application management method includes: obtaining a control instruction for managing a set of applications in at least one smart interaction tablet in a plurality of smart interaction tablets, wherein the set of applications comprises at least one application; and sending the control instruction to the at least one smart interaction tablet, such that sets of applications in all the smart interaction tablets are updated according to the control instruction.

### CROSS-REFERENCE TO RELATED APPLICATIONS

This application is a National Stage of International Application No. PCT/CN2020/125462, filed Oct. 30, 2020, which is hereby incorporated by reference in its entirety.

### FIELD

The present disclosure relates to the technical field of electronics, in particular to an application management method and system for a terminal.

### BACKGROUND

With the development of an intelligent technology, smart interaction tablets based on a touch control technology are gradually applied to various aspects of daily life, such as conferences and teaching.

The smart interaction tablets may be integrated devices that control the content displayed on a display tablet and realize human-computer interaction operation through the touch control technology, which integrate one or more functions such as a projector, an electronic whiteboard, a curtain, a speaker, a television and a video conference terminal. Generally, the smart interaction tablets include at least one display screen, and the display screen may be a capacitive, resistive, or electromagnetic screen.

### SUMMARY

The present disclosure provides an application management method and system for a terminal, and a specific solution is as follows.

An embodiment of the present disclosure provides an application management method for a terminal, applied to a management end, wherein the terminal is composed of at least one smart interaction tablet, and the application management method includes: obtaining a control instruction for managing a set of applications in at least one smart interaction tablet, wherein the set of applications includes at least one application; and sending the control instruction to the at least one smart interaction tablet, such that sets of applications in all smart interaction tablets are updated according to the control instruction.

Optionally, in some embodiments of the present disclosure, sending the control instruction to the at least one smart interaction tablet, such that the sets of applications in all the smart interaction tablets are updated according to the control instruction includes: sending the control instruction to the at least one smart interaction tablet, such that all the smart interaction tablets call Framework layers through management applications installed on the smart interaction tablets to control the sets of applications in all the smart interaction tablets to be in silent updating.

Optionally, in some embodiments of the present disclosure, before obtaining the control instruction for managing the set of applications in the at least one smart interaction tablet, the method further includes: obtaining an application list; receiving editing operation used by a user to adjust application parameters in the application list, wherein the application parameters include at least one of a version number, an icon, a size, a download address or a name; and obtaining an updated application list in response to the editing operation.

Optionally, in some embodiments of the present disclosure, before obtaining the control instruction for managing the set of applications in the at least one smart interaction tablet, the method further includes: obtaining an installation package; and adding applications corresponding to the installation package to the application list, and obtaining an updated application list.

Optionally, in some embodiments of the present disclosure, after obtaining the updated application list, the method further includes: selecting a target application from the updated application list; obtaining a device list including the at least one smart interaction tablet, and selecting a target smart interaction tablet from the device list; and pushing the selected target application to the target smart interaction tablet.

Optionally, in some embodiments of the present disclosure, after obtaining the application list, the method further includes: classifying at least part of applications in the application list.

Optionally, in some embodiments of the present disclosure, the method further includes: obtaining a device list including the at least one smart interaction tablet; and according to the device list, performing addition and deletion processing on the smart interaction tablet included in the terminal.

Optionally, in some embodiments of the present disclosure, after obtaining the device list including the at least one smart interaction tablet, the method further includes: grouping the at least one smart interaction tablet according to the device list.

Optionally, in some embodiments of the present disclosure, sending the control instruction to the at least one smart interaction tablet includes: sending the control instruction to the at least one smart interaction tablet through an MQTT (Message Queuing Telemetry Transport) protocol or an IOT (Internet of Things) protocol.

Correspondingly, an embodiment of the present disclosure further provides an application management system for a terminal, including: a management end and a terminal composed of at least one smart interaction tablet, wherein the management end is configured to obtain a control instruction for managing a set of applications in the at least one smart interaction tablet, wherein the set of applications includes at least one application; and send the control instruction to the at least one smart interaction tablet; and the terminal is configured to receive the control instruction, and respond to the control instruction, and sets of applications in all smart interaction tablets of the at least one smart interaction tablet are updated according to the control instruction.

Optionally, in some embodiments of the present disclosure, the terminal is configured to: call Framework layers through management applications installed on the terminal to perform silent updating on the sets of applications in all the smart interaction tablets receiving the control instruction in the terminal.

Optionally, in some embodiments of the present disclosure, the management end includes a server, and the server is configured to: obtain an application list; receive editing operation used by a user to adjust application parameters in the application list, wherein the application parameters include at least one of a version number, an icon, a size, a download address or a name; and obtain an updated application list in response to the editing operation.

Optionally, in some embodiments of the present disclosure, the server is configured to: obtain an installation package; and add applications corresponding to the installation package to the application list, and obtain an updated application list.

Optionally, in some embodiments of the present disclosure, the server is further configured to: select a target application from the updated application list; obtain a device list including the at least one smart interaction tablet, and select a target smart interaction tablet from the device list; and push the selected target application to the target smart interaction tablet.

Optionally, in some embodiments of the present disclosure, the server is further configured to: classify at least part of applications in the application list.

Optionally, in some embodiments of the present disclosure, the server is further configured to: obtain a device list including the at least one smart interaction tablet; and perform addition and deletion processing on the smart interaction tablet included in the terminal according to the device list.

Optionally, in some embodiments of the present disclosure, the server is further configured to: group the at least one smart interaction tablet according to the device list.

Optionally, in some embodiments of the present disclosure, the server is configured to: send the control instruction to the at least one smart interaction tablet through an MQTT protocol or an IOT protocol.

Optionally, in some embodiments of the present disclosure, the system further includes a verification gateway: the verification gateway being configured to verify legitimacy of the management end and the terminal; and manage the applications of the terminal if the management end and the terminal are both legal.

### BRIEF DESCRIPTION OF THE DRAWINGS

FIG. 1 is a method flow chart of an application management method for a terminal provided by an embodiment of the present disclosure.

FIG. 2 is one of method flow charts before step S101 in an application management method for a terminal provided by an embodiment of the present disclosure.

FIG. 3 is one of method flow charts before step S101 in an application management method for a terminal provided by an embodiment of the present disclosure.

FIG. 4 is a method flow chart after obtaining an updated application list in an application management method for a terminal provided by an embodiment of the present disclosure.

FIG. 5 is one of method flow charts of an application management method for a terminal provided by an embodiment of the present disclosure.

FIG. 6 is a schematic structural diagram of an application management system for a terminal provided by an embodiment of the present disclosure.

FIG. 7 is a schematic structural diagram of an application management apparatus for a terminal provided by an embodiment of the present disclosure.

### DETAILED DESCRIPTION OF THE EMBODIMENTS

To make the objectives, technical solutions and advantages of embodiments of the present disclosure clearer, the technical solutions of the embodiments of the present disclosure will be clearly and fully described below with reference to the accompanying drawings of the embodiments of the present disclosure. Obviously, the described embodiments are one part of embodiments of the present disclosure, not all of them. In addition, the embodiments of the present disclosure and features of the embodiments may be combined with each other without conflict. Based on the described embodiments of the present disclosure, all other embodiments acquired by those ordinarily skilled in the art without creative labor fall within the scope of protection of the present disclosure.

Unless otherwise defined, technical or scientific terms used herein shall have the ordinary meanings understood by those ordinarily skilled in the art to which the present disclosure pertains. “Comprise”, “include” or similar words used in the present disclosure indicate that an element or item appearing before such words covers listed elements or items appearing after the words and equivalents thereof, and do not exclude other elements or items.

For application management of the smart interaction tablets, the application management in the smart interaction tablets is often realized by importing a USB flash disk at present, such as downloading and updating. In addition, the application management in the smart interaction tablets may further be realized by management applications set in the smart interaction tablets, such as “App Market”. However, a user may only manage applications one by one, particularly, when the application management is performed on the plurality of smart interaction tablets, the user needs to manage the applications of the smart interaction tablets one by one. For example, for the different smart interaction tablets, the user needs to manually download the applications for all the smart interaction tablets one by one respectively.

Visibly, when more applications need to be managed, application management efficiency of existing smart interaction tablets is lower.

In the related art, especially when a plurality of smart interaction tablets are managed, it is necessary to separately manage applications required by each smart interaction tablet. For example, the smart interaction tablet A needs to download and install an application a, the smart interaction tablet B needs to update an application b, and a user needs to download and install the application A on an electronic device A through an “App Market” installed on it, and also needs to update the application b on an electronic device B through an “App Market” installed on it. When more applications of the smart interaction tablets need to be managed, the management efficiency is greatly reduced.

In view of this, embodiments of the present disclosure provide an application management method and system for a terminal, used for improving the application management efficiency of smart interaction tablets.

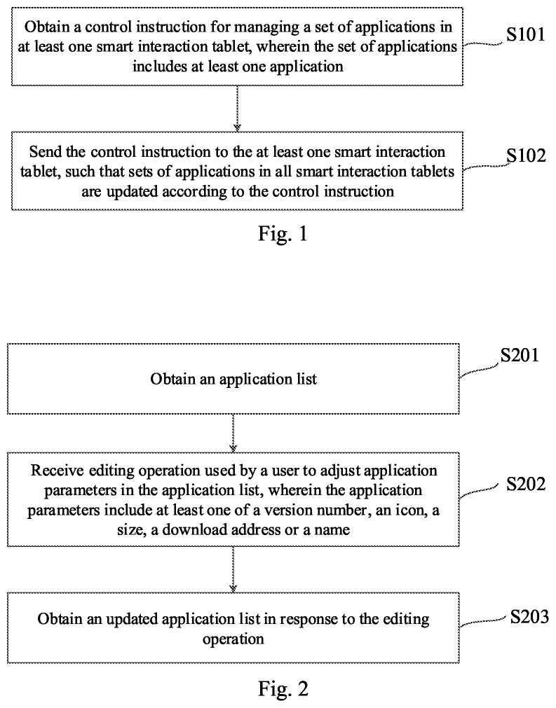

An embodiment of the present disclosure provides an application management method for a terminal as shown in FIG. 1, applied to a management end, wherein the terminal is composed of at least one smart interaction tablet, and the method includes followings.

S101: a control instruction for managing a set of applications in at least one smart interaction tablet is obtained, and the set of applications includes at least one application.

In a specific implementation process, the set of applications in each smart interaction tablet may include at least one application, wherein the control instruction may be a control instruction for managing sets of applications in all smart interaction tablets in the at least one smart interaction tablet composing the terminal, and may be an instruction for managing sets of applications in part of smart interaction tablets in the at least one smart interaction tablet. In the specific implementation process, when application management is performed on the terminal, an administrator may first determine the at least one smart interaction tablet composing the terminal, and then perform unified management on the at least one smart interaction tablet composing the terminal, which improves application management efficiency.

S102: the control instruction is sent to the at least one smart interaction tablet, such that the sets of applications in all the smart interaction tablets are updated according to the control instruction.

In the specific implementation process, the control instruction may be sent to the at least one smart interaction tablet composing the terminal, for example, the control instruction is sent to all the smart interaction tablets composing the terminal and may also be sent to part of smart interaction tablets composing the terminal, and for example, the control instruction is sent to one smart interaction tablet composing the terminal, such that unified management of the applications of the part of smart interaction tablets may be achieved. In addition, after the control instruction is sent to the at least one smart interaction tablet, the sets of applications in all the corresponding smart interaction tablets may be updated according to the control instruction, updating of the corresponding sets of applications in the smart interaction tablets may be version updating of at least part of applications inside, may also be updating of the number of applications in the sets of applications through application unloading, and may also be updating of the number of applications in the sets of applications through application unloading, such that updating management of the sets of applications in the smart interaction tablets is achieved, and even in the case of more smart interaction tablets, unified management of the plurality of smart interaction tablets may still be achieved, which ensures application management efficiency of the smart interaction tablets.

In some embodiments of the present disclosure, step S102: sending the control instruction to the at least one smart interaction tablet, such that the sets of applications in all the smart interaction tablets are updated according to the control instruction includes:
the control instruction is sent to the at least one smart interaction tablet, such that all the smart interaction tablets call Framework layers through management applications installed on the smart interaction tablets to control the sets of applications in all the smart interaction tablets to be in silent updating.

In the specific implementation process, the control instruction may be sent to the at least one smart interaction tablet, operation systems installed on all the smart interaction tablets in the at least one smart interaction tablet may be Android systems, in this case, all the smart interaction tablets in the at least one smart interaction tablet may call the application framework layers through the management applications installed on the smart interaction tablets, specifically, the management applications acquire Android system privilege in a mode of system-level signature and pre-installation, and under this privilege, the management applications achieve silent updating of the sets of applications of the corresponding smart interaction tablets by calling interfaces provided by the Framework layers through a reflection principle. The silent updating may achieve automatic updating of the sets of applications in the smart interaction tablets in a case of not prompting a user, a whole updating process avoids interference to the user, and the silent updating may be silent installation and may also be silent unloading. For example, the administrator directly issues the control instruction of “application a downloading” to the smart interaction tablet A, the user of the smart interaction tablet A downloads the application a into the smart interaction tablet A without feeling, when the smart interaction tablet A downloads the application a, the user of the smart interaction tablet A does not need to perform secondary confirmation, rapid management of the applications in the managed smart interaction tablets may be achieved by the administrator, and the whole application management efficiency is higher.

In some embodiments of the present disclosure, as shown in FIG. 2, in step S101: before obtaining the control instruction for managing the set of applications in the at least one smart interaction tablet, the method further includes:
S201: an application list is obtained;
S202: editing operation used by a user to adjust application parameters in the application list is received, and the application parameters include at least one of a version number, an icon, a size, a download address or a name; and
S203: an updated application list is obtained in response to the editing operation.

In the specific implementation process, specific implementation procedures of step S201 to step S203 are as follows:
firstly, the application list is acquired, and the application list may be a list stored in a local server and may also be a list sent by a cloud server, which is not limited here. Then, editing parameters used by the user to adjust the application parameters in the application list are received, the application parameters include at least one of the version number, the icon, the size, the download address or the name, and in the specific implementation process, the application parameters may further include a download package name, a production company, an application description, etc., which is not limited here. For example, the administrator directly edits the application parameters of an application c in the application list, for example, a name of the application c is set as n, an icon is d, a version number of the application c is 2.0, etc., and certainly, the administrator may perform other editing operation on the applications in the application list according to actual application needs, which is not detailed here. After the editing operation is received, the updated application list is obtained in response to the editing operation. Thus, unified adjustment of the applications required to be managed in the application list is achieved, which improves the application management efficiency.

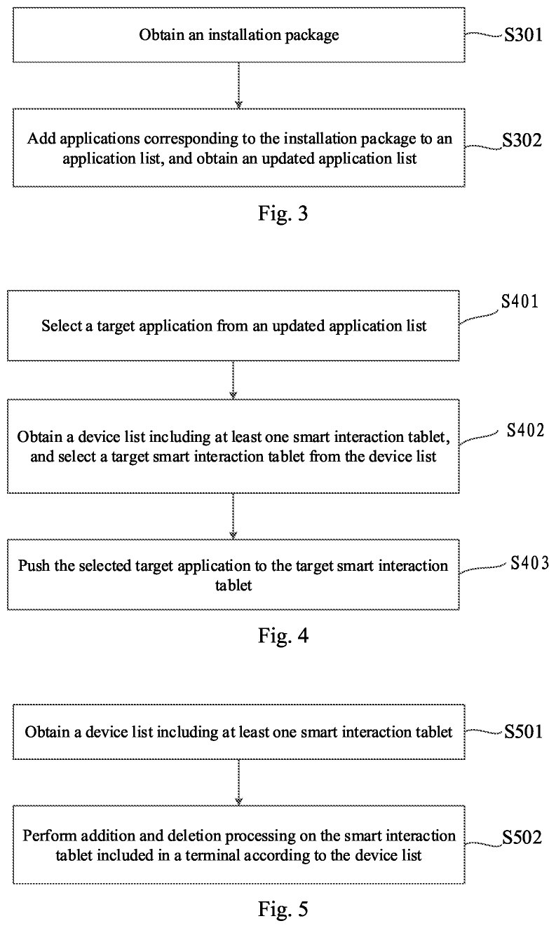

In some embodiments of the present disclosure, as shown in FIG. 3, in step S101: before obtaining the control instruction for managing the set of applications in the at least one smart interaction tablet, the method further includes:
S301: an installation package is obtained; and
S302: applications corresponding to the installation package are added to the application list, and an updated application list is obtained.

In the specific implementation process, specific implementation procedures of step S301 to step S302 are as follows:
firstly, the installation package is obtained, and the installation package may be stored in the local server and may further be sent by the cloud server, which is not limited here. Then, the applications corresponding to the installation package are added to the application list, and the updated application list is obtained. In the actual application, the administrator may trigger obtaining of the installation package through application new-adding operation, then, the applications corresponding to the installation package are added to the application list, and therefore, updating of the application list is achieved. Thus, timely updating of the application list is achieved according to the management needs, which ensures the application management efficiency.

In some embodiments of the present disclosure, as shown in FIG. 4, after the updated application list is acquired through the step S203 or step S302, the method further includes:
S401: a target application is selected from the updated application list;
S402: a device list including the at least one smart interaction tablet is obtained, and a target smart interaction tablet is selected from the device list; and
S403: the selected target application is pushed to the target smart interaction tablet.

In the specific implementation process, specific implementation procedures of step S401 to step S403 are as follows:
firstly, the target application is selected from the updated application list, and the administrator may perform selection operation on at least part of applications in the updated application list according to actual needs, for example, the administrator may click the at least part of applications in the updated application list and may also tick the at least part of applications in the updated application list, which is not limited here. The target application is selected from the updated application list in response to the selection operation, and the target application may be one or more. Then, the target smart interaction tablet is selected from the device list including the at least one smart interaction tablet, the target smart interaction tablet may be one or more, thus, the selected target application may be pushed to the target smart interaction tablet, so as to achieve targeted recommendation of the applications needed by the smart interaction tablet, in addition, when there are a plurality of target smart interaction tablets, the target applications may also be rapidly pushed to the plurality of target smart interaction tablets, and the whole application pushing process efficiency is higher.

In addition, in the specific implementation process, the device list may be a list composed of serial numbers uniquely identifying the smart interaction tablets and may further be a list composed of media access control addresses (MACs) uniquely identifying the smart interaction tablets, which is not limited here. For example, the administrator may directly tick the target smart interaction tablets required to be managed from the device list, and for example, the administrator selects the smart interaction tablet A and the smart interaction tablet B required to be managed from the device list including 100 smart interaction tablets, which is not limited here. In the actual application, the administrator may set a recommendation type of the target applications, for example, the target applications are controlled to be displayed on display interfaces of the target smart interaction tablets in a slideshow mode, such that circular recommendation of the target applications on the target smart interaction tablets is achieved, and thus, individual recommendation of the applications of the smart interaction tablets is achieved according to management needs.

In some embodiments of the present disclosure, in step S201: after obtaining the application list, the method further includes:
at least part of applications in the application list are classified.

In the specific implementation process, classifying management may further be performed on the at least part of applications in the application list, the at least part of applications in the application list may be classified according to characters, forms, images and network communication, the at least part of applications in the application list may further be classified according to audios and videos, and the at least part of applications in the application list may further be classified by adopting other classifying principles according to the actual application management needs, which is not limited here. For example, types of the application a, the application b and the application c in the application list are set as L1, types of an application d and an application e are set as L2, such that unified classifying of the applications required to be managed by the at least one smart interaction tablet included in the terminal is achieved, which improves the application classifying efficiency. Thus, in the specific implementation process, after the at least part of applications in the application list are classified, then, when the classified applications are recommended to the at least one smart interaction tablet included in the terminal, for a user of the at least one smart interaction tablet, classifying is not needed, and thus the application classifying efficiency of the smart interaction tablet is improved.

In some embodiments of the present disclosure, as shown in FIG. 5, the method further includes:
S501: the device list including the at least one smart interaction tablet is obtained; and
S502: addition and deletion processing is performed on the smart interaction tablets included in the terminal according to the device list.

In the specific implementation process, specific implementation procedures of step S501 to step S502 are as follows:
firstly, the device list of the at least one smart interaction tablet included in the terminal is obtained, and the device list may be a list composed of serial numbers uniquely identifying the smart interaction tablets and may further be a list composed of media access control addresses (MACs) uniquely identifying the smart interaction tablets, which is not limited here. Then, addition and deletion processing is performed on the smart interaction tablets included in the terminal according to the device list. In the actual application, the administrator may perform addition or deletion on the smart interaction tablets required to be managed according to the management needs, for example, the smart interaction tablet D is added into the device list, thus, the administrator may perform application management on the smart interaction tablet D, and the other example is that the smart interaction tablet E is deleted from the device list, and therefore the application management does not need to be performed on the smart interaction tablet D. Therefore, flexible management on the smart interaction tablets included in the terminal is achieved.

In some embodiments of the present disclosure, in step S501: after obtaining the device list including the at least one smart interaction tablet, the method further includes:
the at least one smart interaction tablet is grouped according to the device list.

In the specific implementation process, after the device list including the at least one smart interaction tablet is obtained, the at least one smart interaction tablet in the device list may further be grouped, for example, the smart interaction tablet A, the smart interaction tablet B and the smart interaction tablet C are all set as a first group, the smart interaction tablet D and the smart interaction tablet are both set as a second group, and therefore rapid grouping of the smart interaction tablets is achieved. In the specific implementation process, after the smart interaction tablets are grouped, the smart interaction tablets in the same group may further be selected for application recommendation, for example, the application a is recommended to all the smart interaction tablets in the first group, and therefore the application recommendation efficiency is improved. In the embodiment of the present disclosure, step S102: sending the control instruction to at least one smart interaction tablet includes:
sending the control instruction to at least one smart interaction tablet through the MQTT protocol or IOT protocol.

In the specific implementation process, the control instruction may be sent to at least one smart interaction tablet through an MQTT (message queuing telemetry transport) protocol, and the control instruction may further be sent to the at least one smart interaction tablet through the IOT (Internet of Things) protocol. In the actual application, the control instruction may be sent to the at least one smart interaction tablet through the MQTT protocol or IOT protocol, thus, control over one smart interaction tablet in the at least one smart interaction tablet is achieved through the control instruction, and control over the plurality of smart interaction tablets in the at least one smart interaction tablet may further be achieved through the control instruction.

In addition, in some embodiments of the present disclosure, state information reported by all the smart interaction tablets may further be received, specifically, the state information may be information reported in real time and may further be information reported at preset intervals, thus, the administrator may perform timely and effective monitoring on all the smart interaction tablets in the terminal, and the state information may include information used for representing a device online state, information used for representing a device offline state and abnormal log information, which is not limited here. In addition, when an abnormal state is monitored, alarm information such as sound and light may further be output.

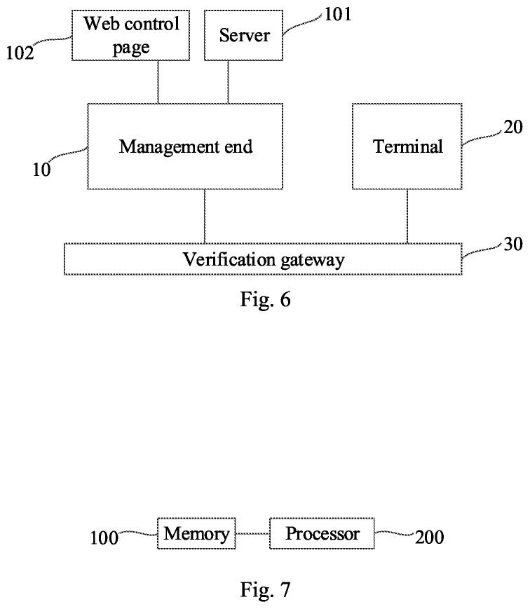

Based on the same disclosed conception, as shown in FIG. 6, an embodiment of the present disclosure provides an application management system for a terminal, including:
a management end 10 and a terminal 20 including at least one smart interaction tablet, wherein
the management end 10 is configured to obtain a control instruction for managing a set of applications in at least one smart interaction tablet, wherein the set of applications includes at least one application; and send the control instruction to the at least one smart interaction tablet; and
the terminal 20 is configured to receive the control instruction, and respond to the control instruction, and sets of applications in all smart interaction tablets of the at least one smart interaction tablet are updated according to the control instruction.

In some embodiments of the present disclosure, the terminal 20 is configured to:
call Framework layers through management applications installed on the terminal to perform silent updating on the sets of applications in all the smart interaction tablets receiving the control instruction in the terminal.

In some embodiments of the present disclosure, the management end 10 includes a server 101, and the server 101 is configured to:
obtain an application list;
receive editing operation used by a user to adjust application parameters in the application list, wherein the application parameters include at least one of a version number, an icon, a size, a download address or a name; and
obtain an updated application list in response to the editing operation. In the embodiment of the present disclosure, the server 101 is configured to:
obtain an installation package; and
add applications corresponding to the installation package to the application list, and obtain an updated application list.

In some embodiments of the present disclosure, the server 101 is further configured to:
select a target application from the updated application list;
obtain a device list including the at least one smart interaction tablet, and select a target smart interaction tablet from the device list; and
push the selected target application to the target smart interaction tablet. In the embodiment of the present disclosure, the server 101 is further configured to:
classify at least part of applications in the application list. In the embodiment of the present disclosure, the server 101 is further configured to:
obtain the device list including the at least one smart interaction tablet; and
perform addition and deletion processing on the smart interaction tablet included in the terminal according to the device list.

In some embodiments of the present disclosure, the server 101 is further configured to:
group the at least one smart interaction tablet according to the device list.

In the specific implementation process, the management end 10 further includes a web control page 102, the web control page 102 may display contents such as working states, application classifying situations and grouping situations of the application list, the device list and the smart interaction tablets, and certainly, a specific layout of the web control page may further be designed according to actual application situations, which is not detailed here.

In some embodiments of the present disclosure, the server 101 is configured to:
send the control instruction to the at least one smart interaction tablet through the MQTT protocol or IOT protocol.

In some embodiments of the present disclosure, the system further includes a verification gateway 30:
the verification gateway 30 being configured to verify legitimacy of the management end 10 and the terminal 20; and
if the management end 10 and the terminal 20 are both legal, the management end 10 managing the applications of the terminal 20.

In the specific implementation process, the verification gateway 30 verifies the legitimacy of the management end 10, may verify login identity of the administrator and may also verify registration information of all the smart interaction tablets in the terminal 20, and certainly, verification may further be performed in other modes, which is not limited here.

Based on the same disclosed conception, as shown in FIG. 7, an embodiment of the present disclosure further provides an application management apparatus for a terminal, including:
a memory 100 and a processor 200; wherein
the memory 100 is configured to store a computer program; and
the processor 200 is configured to execute the computer program in the memory 100 to achieve following steps:
a control instruction for managing a set of applications in at least one smart interaction tablet is obtained, and the set of applications includes at least one application; and
the control instruction is sent to the at least one smart interaction tablet, such that sets of applications in all the smart interaction tablets are updated according to the control instruction.

Optionally, the processor 200 may be a central processing unit and an application specific integrated circuit (ASIC) and may be one or more integrated circuits configured to control program execution.

Optionally, the memory 100 may include a read only memory (ROM for short), a random access memory (RAM for short) and a disk memory. The memory 100 is configured to store data needed when the processor 200 operates, that is, the memory stores the computer program executable by the processor 200, the processor 200 executes the method shown in FIG. 1 by executing the computer program stored by the memory 100, the number of the memory 100 is one or more, and the number of the processor 200 is one or more.

The apparatus may be configured to execute the method provided by embodiments shown in FIG. 1, for example, the control instruction for managing the set of applications in the at least one smart interaction tablet is obtained, and the set of applications includes at least one application; and the control instruction is sent to the at least one smart interaction tablet, such that sets of applications in all the smart interaction tablets are updated according to the control instruction. Therefore, functions able to be achieved by all function modules in the apparatus may refer to corresponding descriptions in the embodiments as shown in FIG. 1, which is not repeated.

An embodiment of the present disclosure further provides a computer storage medium, wherein the computer storage medium stores a computer instruction, and when the computer instruction operates on a computer, the computer executes the above application management method for the terminal.

Those skilled in the art will appreciate that the embodiments of the present disclosure may be provided as methods, systems, or computer program products. Therefore, the present disclosure may take the form of a full hardware embodiment, a full software embodiment, or an embodiment combining software and hardware. Besides, the present disclosure may adopt the form of a computer program product implemented on one or more computer readable storage media (including but not limited to a disk memory, a CD-ROM, an optical memory and the like) containing computer available program codes.

The present disclosure is described with reference to the flow charts and/or block charts of the method, device (system), and computer program product according to the embodiments of the present disclosure. It should be understood that each flow and/or block in the flow chart and/or block chart and the combination of flows and/or blocks in the flow chart and/or block chart may be implemented by computer program instructions. These computer program instructions can be provided to processors of a general-purpose computer, a special-purpose computer, an embedded processor or other programmable data processing devices to generate a machine, so that instructions executed by processors of a computer or other programmable data processing devices generate an apparatus for implementing the functions specified in one or more flows of the flow chart and/or one or more blocks of the block chart.

These computer program instructions may also be stored in a computer-readable memory capable of guiding a computer or other programmable data processing devices to work in a specific manner, so that instructions stored in the computer-readable memory generate a manufacturing product including an instruction apparatus, and the instruction apparatus implements the functions specified in one or more flows of the flow chart and/or one or more blocks of the block chart.

These computer program instructions may also be loaded on a computer or other programmable data processing devices, so that a series of operation steps are executed on the computer or other programmable devices to produce computer-implemented processing, and thus, the instructions executed on the computer or other programmable devices provide steps for implementing the functions specified in one or more flows of the flow chart and/or one or more blocks of the block diagram.

Although the preferred embodiments of the present disclosure have been described, those skilled in the art may make additional changes and modifications on these embodiments once they know the basic creative concept. So the appended claims are intended to be construed to include the preferred embodiments and all changes and modifications that fall into the scope of the present disclosure.

Obviously, those skilled in the art may make various modifications and variations to the present disclosure without departing from the spirit and scope of the present disclosure. In this way, if these modifications and variations of the present disclosure fall within the scope of the claims of the present disclosure and equivalent technologies thereof, the present disclosure is also intended to include these modifications and variations.

1. An application management method for a terminal, applied to a management end, wherein the terminal comprises at least one smart interaction tablet, and the application management method comprises:
obtaining a control instruction for managing a set of applications in the at least one smart interaction tablet, wherein the set of applications comprises at least one application; and
sending the control instruction to the at least one smart interaction tablet, such that the set of applications in the at least one smart interaction tablet is updated according to the control instruction.

2. The method according to claim 1, wherein the sending the control instruction to the at least one smart interaction tablet, such that the set of applications in the at least one smart interaction tablet is updated according to the control instruction, comprises:
sending the control instruction to the at least one smart interaction tablet, such that the at least one smart interaction tablet calls a Framework layer through a management application installed on the at least one smart interaction tablet to control the set of applications in the at least one smart interaction tablet to be in silent updating.

3. The method according to claim 1, wherein before the obtaining the control instruction for managing the set of applications in the at least one smart interaction tablet, the method further comprises:
obtaining an application list;
receiving an editing operation used by a user to adjust application parameters in the application list, wherein the application parameters comprise at least one of a version number, an icon, a size, a download address or a name; and
obtaining an updated application list in response to the editing operation.

4. The method according to claim 1, wherein before the obtaining the control instruction for managing the set of applications in the at least one smart interaction tablet, the method further comprises:
obtaining an installation package; and
adding applications corresponding to the installation package to the application list, and obtaining an updated application list.

5. The method according to claim 3, wherein after the obtaining the updated application list, the method further comprises:
selecting a target application from the updated application list;
obtaining a device list comprising the at least one smart interaction tablet, and selecting a target smart interaction tablet from the device list; and
pushing a selected target application to the target smart interaction tablet.

6. The method according to claim 3, wherein after the obtaining the application list, the method further comprises:
classifying at least part of applications in the application list.

7. The method according to claim 1, further comprising:
obtaining a device list comprising the at least one smart interaction tablet; and
adding or deleting smart interaction tablets comprised in the terminal according to the device list.

8. The method according to claim 7, wherein after the obtaining the device list comprising the at least one smart interaction tablet, the method further comprises:
grouping the at least one smart interaction tablet according to the device list.

9. The method according to claim 1, wherein the sending the control instruction to the at least one smart interaction tablet comprises:
sending the control instruction to the at least one smart interaction tablet through a Message Queuing Telemetry Transport, MQTT, protocol or an Internet of Thins, IOT, protocol.

10. An application management system for a terminal, comprising:
a management end and a terminal comprising at least one smart interaction tablet, wherein the management end is configured to obtain a control instruction for managing a set of applications in at least one smart interaction tablet, and send the control instruction to the at least one smart interaction tablet; wherein the set of applications comprises at least one application; and
the terminal is configured to receive the control instruction, and respond to the control instruction, wherein the set of applications in the at least one smart interaction tablet is updated according to the control instruction.

11. The system according to claim 10, wherein the terminal is configured to:
call a Framework layer through management applications installed on the terminal to perform silent updating on the set of application in the at least one smart interaction tablet receiving the control instruction in the terminal.

12. The system according to claim 10, wherein the management end comprises a server, and the server is configured to:
obtain an application list;
receive an editing operation used by a user to adjust application parameters in the application list, wherein the application parameters comprise at least one of a version number, an icon, a size, a download address or a name; and
obtain an updated application list in response to the editing operation.

13. The system according to claim 10, wherein the server is configured to:
obtain an installation package; and
add applications corresponding to the installation package to the application list, and obtain an updated application list.

14. The system according to claim 12, wherein the server is further configured to:
select a target application from the updated application list;
obtain a device list comprising the at least one smart interaction tablet, and select a target smart interaction tablet from the device list; and
push a selected target application to the target smart interaction tablet.

15. The system according to claim 12, wherein the server is further configured to:
classify at least part of applications in the application list.

16. The system according to claim 12, wherein the server is further configured to:
obtain a device list comprising the at least one smart interaction tablet; and
adding or deleting smart interaction tablets comprised in the terminal according to the device list.

17. The system according to claim 16, wherein the server is further configured to:
group the at least one smart interaction tablet according to the device list.

18. The system according to claim 12, wherein the server is configured to:
send the control instruction to the at least one smart interaction tablet through a Message Queuing Telemetry Transport, MQTT, protocol or an Internet of Thins, IOT, protocol.

19. The system according to claim 10, further comprising a verification gateway:
the verification gateway being configured to verify legitimacy of the management end and the terminal, and manage the applications of the terminal in response to the management end and the terminal being legal.
